(19) United States
(12) Patent Application Publication
(10) Pub. No.: US 2019/0378477 A1
(43) Pub. Date: Dec. 12, 2019

(54) IMAGE PROCESSING SYSTEM AND MEMORY MANAGING METHOD THEREOF

(71) Applicant: MStar Semiconductor, Inc., Hsinchu Hsien (TW)

(72) Inventor: He-Yuan LIN, Hsinchu Hsien (TW)

(21) Appl. No.: 16/050,224

(22) Filed: Jul. 31, 2018

(30) Foreign Application Priority Data
Jun. 6, 2018 (TW) 107119551

(51) Int. Cl. G09G 5/39; G06F 12/0802; G06F 17/30

(52) U.S. Cl. CPC G09G 5/39; G06F 12/0802; G06F 2212/60; G09G 2360/121; G06F 17/30979

(57) ABSTRACT

An image processing system suitable for accessing a main memory includes a cache, an image processing circuit and a memory controller. The memory controller includes a hit calculating circuit, a deciding circuit and a fetching circuit. In response to a data request issued by the image processing circuit for a set of target image data, the hit calculating circuit calculates a hit rate of the set of target image data in the cache. The deciding circuit generates a prefetch decision according to the hit rate to indicate whether to perform a prefetch procedure. The fetching circuit selectively performs the prefetch procedure on the main memory according to the prefetch decision.

This application claims the benefit of Taiwan application Serial No. 107119551, filed Jun. 6, 2018, the subject matter of which is incorporated herein by reference.

### BACKGROUND OF THE INVENTION

### Field of the Invention

The invention relates an image processing system, and more particularly to a technology for enhancing memory utilization efficiency in an image processing system.

### Description of the Related Art

To buffer data used in an image processing process, many image processing systems use dynamic random access memory (DRAM) as a main memory, and uses static random access memory (SRAM) as a cache. Compared to a main memory, a cache has a faster data access speed but a higher hardware cost. Thus, a cache is only used for storing a small amount of image data recently having been used or immediately to be used, whereas a main memory is for storing complete image data of one or multiple video frames.

FIG. 1 shows a partial function diagram of an image processing system. When an image processing system 110 needs image data, it issues a data request to a memory controller 120 to inform the memory controller of position information of the image data (e.g., in which coordinate range in which video frame the image data is located), and the memory controller 120 first accordingly searches a cache 130. If the image data cannot be found in the cache 130, the memory controller 120 issues a fetch request to a main memory 140, and duplicates the image data from the main memory 140 to the cache 130 for the image processing circuit 110 to use. A situation where required data can be found in the cache 130 is referred to as a cache hit, otherwise it is referred to as a cache miss.

Many memory controllers 120 adopt a prefetch technique; that is, it is predicted which image data may be needed by the image processing circuit 110, and such image data is duplicated in advance from the main memory 140 to the cache 130. FIGS. 2(A) to 2(E) illustrate a prefetch mechanism. When an image processing process is performed, each video frame is divided into multiple blocks as a basic unit for image processing. For example, a video frame 200 in FIG. 2(A) includes blocks 001 to 003. Assume that, after a parsing process, the image processing circuit 110 is informed that when processing the block 001, image data in a region R1 shown in FIG. 2(B) is required. Under the circumstances that the prefetch mechanism is adopted, the memory controller 120 reads out image data including the region R1 and in a greater range, e.g., the image data in a region R1′ larger than region R1 in FIG. 2(C) required for performing image processing for subsequent blocks. However, when the memory controller 120 processes the block 002, the same prefetch mechanism is adopted. In addition to a region R2 needed for processing the block 002 as shown in FIG. 2(D), the memory controller 120 fetches a region R2′ shown in FIG. 2(E) which is a greater range than region R2. As shown in the drawings, the region R1′ and the region R2′ have an overlapping area, meaning that a cache hit will occur when the memory controller 120 reads the region R2′. Relatively speaking, the amount of data that needs to be duplicated from the main memory 140 to the cache 130 when the memory controller 120 is to read the region R2′ at this point is reduced, meaning that the length of burst data is reduced. An inadequately short burst length significantly affects the access efficiency of the main memory, with associated details given below.

Starting from when the memory controller 120 informs the main memory 140 to read data at a particular address to when the main memory 140 actually outputs data, a main time delay amount in between is referred to as column address strobe latency (to be referred to as CAS latency), which is a critical indicator for evaluating memory efficiency. In regard to a current DRAM, the main memory 140 includes multiple memory banks, and only one of these memory banks is active at the same time point. In general, CAS latency consists of two delay periods. If a memory bank storing required data is originally inactive, the memory bank needs to be first switched to an active state, and such switching time is the first delay period. The second delay period is the time needed by the active memory bank to transmit data to an output terminal of the main memory 140. For the same main memory 140, the first delay period is a constant value irrelevant to the amount data that needs to be fetched, whereas the length of the second delay period is a variable value directly proportional to the amount of data that needs to be fetched.

FIG. 3 shows a schematic diagram of respective CAS latency of two fetch behaviors. Assuming that the time length of the first delay period is T1 and the length for fetching each set of data in the second delay period is T2. Assuming that 20 sets of data is to be fetched from the same memory bank, the CAS latency when a single fetch is performed is (T1+T2*20), and the CAS latency when two fetches are performed is (T1*2+T2*20). It is seen that, it is more efficient to consecutively fetch multiple sets of data in one single fetch in one same memory bank. Further, if the data that needs to be fetched is distributed in multiple memory banks, the CAS latency is also caused to increase noticeably.

With the progress in manufacturing processes, the data rate of newer generation DRAMs also gets higher, meaning that the above time length T2 becomes shorter. However, the absolute time length of the first delay period T1 is not proportionally reduced along with the increase in the data rate. Because the ratio of first delay period T1 in the CAS latency cannot be overlooked, appropriately planning fetching behaviors on the main memory 140 (e.g., consecutively fetching multiple sets of data in one single fetch whenever possible) gets even more critical.

One issue of a current prefetch mechanism is that the utilization efficiency of the main memory 140 is not taken into account; the memory controller 120 may fetch image data from the main memory 140 by multiple times in a fragmented manner, resulting in degraded utilization efficiency of the main memory 140.

### SUMMARY OF THE INVENTION

To resolve the above issue, the present invention provides an image processing system and a memory managing method thereof.

An image processing system suitable for accessing a main memory is provided according to an embodiment of the present invention. The image processing system includes a cache, an image processing circuit and a memory controller. The memory controller includes a hit calculating circuit, a deciding circuit and a fetching circuit. In response to a data request issued by the image processing circuit for a set of target image data, the hit rate calculating circuit calculates a cache hit rate of the set of target image data in the cache. The deciding circuit generates a prefetch decision according to the cache hit rate to indicate whether to perform a prefetch procedure. The fetching circuit selectively performs the prefetch procedure on the main memory according to the prefetch decision.

A memory managing method cooperating with an image processing system is provided according to another embodiment of the present invention. The image processing system is suitable for accessing a main memory, and includes a cache and an image processing circuit. The memory managing method includes: (a) in response to a data request issued by the image processing circuit for a set of target image data, calculating a cache hit rate of the set of target image data in the cache; (b) generating a prefetch decision according to the cache hit rate to indicate whether a prefetch procedure is to be performed; and (c) selectively performing the prefetch procedure on the main memory according to the prefetch decision.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a partial function block diagram of an image processing system;

FIGS. 2(A) to 2(E) (prior art) illustrate a prefetch mechanism;

FIG. 3 (prior art) shows a schematic diagram of respective column address strobe (CAS) latency of two fetching behaviors;

FIG. 4 is a function block diagram of an image processing system according to an embodiment of the present invention;

FIGS. 5(A) and 5(C) are two detailed schematic diagrams of a hit calculating circuit according to embodiments of the present invention; FIG. 5(B) is a schematic diagram of an address table and a searching circuit according to an embodiment of the present invention;

FIG. 6 is a detailed schematic diagram of another memory controller according to another embodiment of the present invention; and

FIG. 7 is a flowchart of a memory managing method according to an embodiment of the present invention.

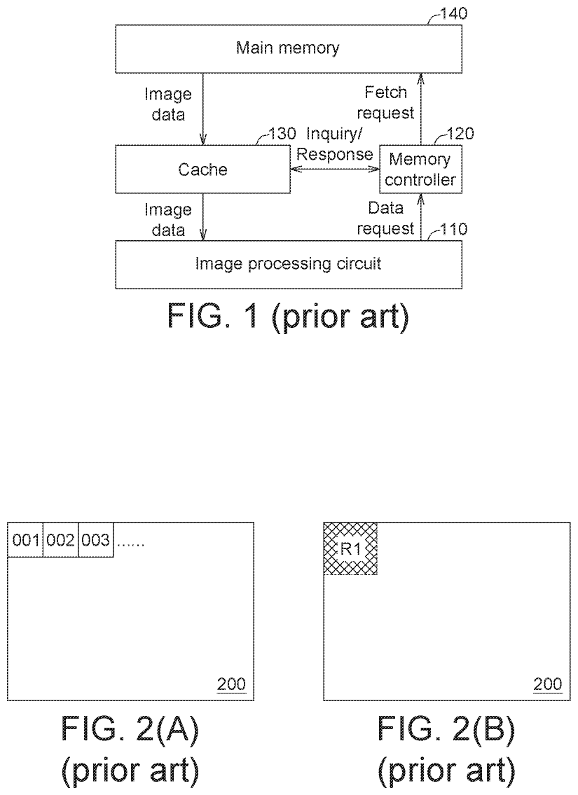

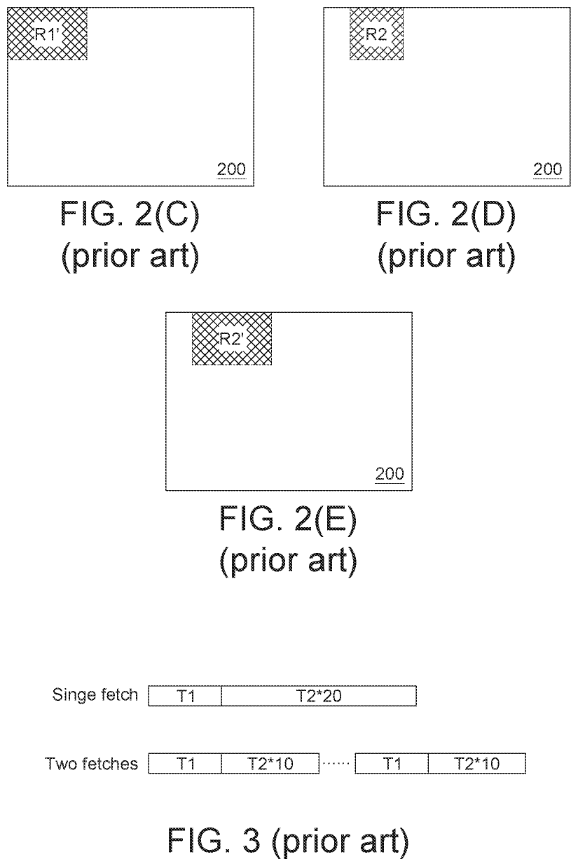

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

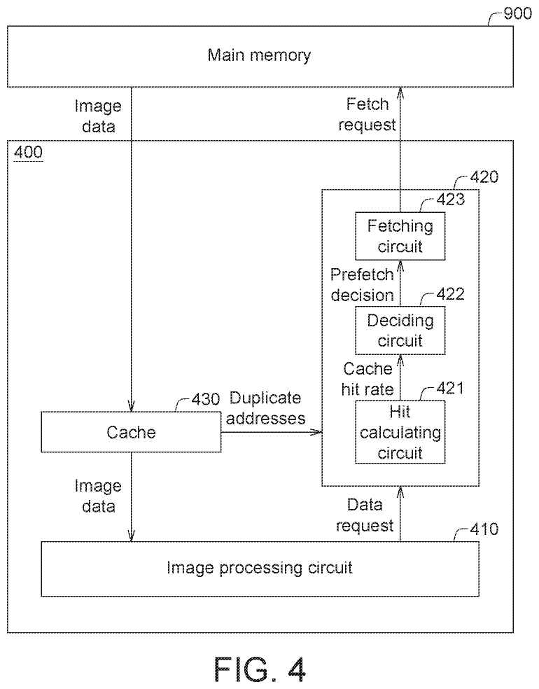

FIG. 4 shows a function block diagram of an image processing system according to an embodiment of the present invention. The image processing system 400 includes an image processing circuit 410, a memory controller 420 and a cache 430. The image processing system 400 is suitable for accessing a main memory 900. In a practical application, for example, the cache 430 may be a static random access memory (SRAM), and the main memory 900 may be a dynamic random access memory (DRAM). As shown in FIG. 4, the memory controller 420 includes a hit calculating circuit 421, a deciding circuit 422 and a fetching circuit 423. Operation details of the above circuits are given below.

The image processing circuit 410 performs one or more image processing processes. For example, if the image processing system 400 is a video signal receiving terminal, the image processing circuit 410 may include a motion compensation circuit for sequentially reconstructing multiple image blocks according to multiple sets of motion vectors and residuals. Each time an image processing process is to be performed, the image processing circuit 410 issues to the memory controller 420 a data request for image data (to be referred to as a set of target image data) needed for the image processing process, and informs the memory controller 420 of position information of the set of target image data.

In response to the data request issued by the image processing circuit 410, the hit calculating circuit 421 calculates a cache hits of the set of target image data in the cache 430. In the current cache memory structure, a cache includes multiple cache lines, and each cache line includes multiple fields including correctness, tag, index, offset and data. When a batch of data is duplicated from the main memory 900 to the cache 430, original addresses of the batch of data in the main memory 900 are divided into three parts, which are distributed and stored in the three fields of tag, index and offset. In other words, by combining the contents in the three fields of tag, index and offset, complete addresses of the batch of data can be obtained. In practice, the hit calculating circuit 421 may calculate the cache hit rate according to the contents of these fields. Associated details are given below.

Assume the set of target image data is distributed in multiple addresses in the main memory 900. If the cache 430 is a single-set cache, the hit calculating circuit 421 may search the correctness field, tag field and index field in the cache 430 according to each of the multiple addresses, so as to determine whether the address has a cache hit and to further calculate the overall cache hit rate of the set of target image data.

If the cache 430 is a multi-set cache and a least recently used (LRU) algorithm is used as a data replacement policy thereof, the hit calculating circuit 421 may be designed to perform searching without triggering the related replacement mechanism of the cache 430, or designed to perform searching without replacing any contents of the fields of the cache 430, thus avoiding any interference on data importance sorting of the cache 430.

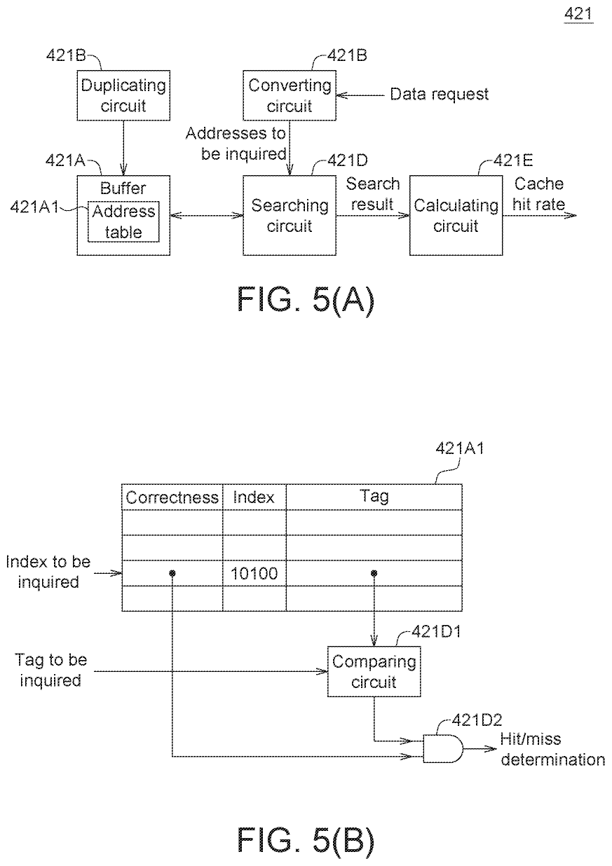

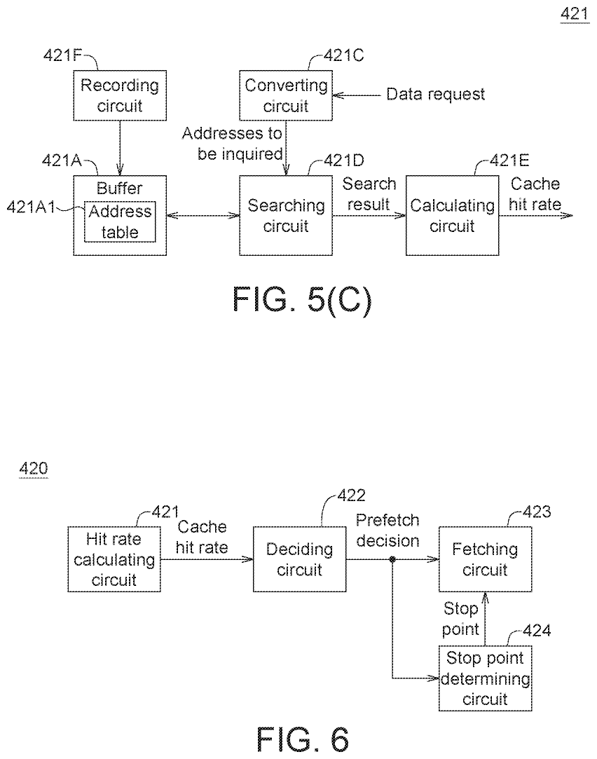

In another embodiment, to avoid interference on data importance sorting of the cache 430, the hit calculating circuit 421 is designed to search duplications of address related fields of the cache 430 through a simulation mechanism, rather than directly searching address related fields of the cache 430. FIG. 5(A) shows a detailed schematic diagram of such type of hit calculating circuit 421 according to an embodiment. In this embodiment, the calculating circuit 421 includes a buffer 421A, a duplicating circuit 421B, a converting circuit 421C, a searching circuit 421D and a calculating circuit 421E. The buffer 421A is provided with an address table 412A1 for simulating address related fields in the cache 430. More specifically, the duplicating circuit 421B duplicates contents of the correctness field, index field and tag field in the cache 430 to the address table 421A1. Each time there is a change in the contents in these fields in the cache 430, the duplicating circuit 421B also duplicates the change and correspondingly modifies the address table 421A1, thereby keeping the contents of the address table 421A1 to be consistent with the contents in these fields in the cache 430. The converting circuit 421C converts the data request issued by the image processing circuit 410 to a set of addresses to be inquired (with a mapping relationship existing between the two). The searching circuit 421D searches in the address table 421A1 for the set of addresses to be inquired to accordingly generate a search result to indicate whether the image data corresponding to the set of addresses to be inquired is already stored in the cache 430. The calculating circuit 421E calculates multiple search results corresponding to multiple sets of addresses to generate a cache hit rate.

FIG. 5(B) shows a schematic diagram of the address table 421A1 and the searching circuit 421D according to an embodiment of the present invention. Assume that the address to be inquired includes two parts—the index and the tag. The searching circuit 421D first identifies a horizontal row in the address table 421A where the horizontal row having an index value same as (e.g., the horizontal row having an index value of 10100 in the drawing) the index in the address to be inquired. The comparing circuit 421D1 fetches the content of the tag of the horizontal row and compares the same with the tag in the address to be inquired. If the comparing circuit 421D1 determines a matching result and the correctness field in the horizontal row indicates that the contents of the horizontal row are correct, an output signal of an AND gate 421D2 indicates that the current inquiry is a cache hit.

It should be noted that, if the data request issued by the image processing circuit 410 directly includes the address of the set of target image data in the main memory 900, the converting circuit 421C in FIG. 5(A) can be omitted.

It is seen from the above description that, the inquiry task of the searching circuit 421D is to obtain the hit rate instead of physically fetching data from the cache 430. Having the searching circuit 421D search the address table 421A1 rather than directly inquiring (fetch) the tag field and index field of the cache 430 can avoid any interference on data importance sorting of the cache 430. It should be noted that, because other fields in the cache 430 are not required to be also duplicated to the buffer 421A, the buffer 421A does not require a large capacity.

FIG. 5(C) shows a schematic diagram of the hit calculating circuit 421 according to another embodiment of the present invention. In this embodiment, the duplicating circuit 421B is replaced by a recording circuit 421F, which records in the address table 421A1 multiple addresses of multiple sets of image data recently stored into the cache 430. For example, the recording circuit 421F may record 500 most recent sets of image data in form of first-in-first-out (FIFO). Compared to FIG. 5(A), the hit calculating circuit 421 in FIG. 5(C) has a simpler operation and can be implemented by a lower hardware cost.

As shown in FIG. 4, the deciding circuit 422 generates a prefetch decision according to the cache hit rate provided by the hit calculating circuit 421 to indicate whether a prefetch procedure is to be performed. If the prefetch decision indicates that the prefetch procedure is to be performed, the fetching circuit 423 accordingly performs the prefetch procedure on the main memory 900. In one embodiment, if the cache hit rate indicates that the target image data currently needed by the image processing circuit are all stored in the cache 430, the deciding circuit 422 has the prefetch decision indicate “not perform the prefetch procedure”. Thus, the memory controller 420 does not perform the prefetch procedure for fetching data possibly needed by a subsequent image processing process from the main memory 900. In contrast, if the cache hit rate indicates that not all of the target image data currently needed by the image processing circuit 410 are stored in the cache 430, the deciding circuit 422 has the prefetch decision indicate “perform the prefetch procedure”. That is to say, when the memory controller 420 decides to “perform the prefetch procedure” according to the deciding circuit 422, the step of “perform the prefetch procedure” includes fetching the data below: (a) duplicating cache miss data from the main memory 900 to the cache 430 for the target image data; and (b) performing the prefetch procedure on the main memory 900 to fetch other data not directly associated with the target image data for image processing of a next set of image data.

It is seen from the above details that, whether the prefetch procedure is to be performed is determined according to whether the cache hit rate is 100%. However, in other embodiments of the present invention, the deciding circuit may generate a prefetch decision according to a cache hit rate other than a 100% cache hit rate.

It is seen from the above description that, the memory controller 420 does not perform a prefetch procedure each time a data request issued by the image processing circuit 410 is received. In the above embodiments, each time the memory controller 420 fetches image data from the main memory 900, the target of fetching necessarily includes the part of cache miss in the target image data and image data desired to be prefetched. In other words, the memory controller 420 does not perform the fetch procedure on the main memory 900 only for the part of cache miss in the target data, nor does it perform the fetch procedure on the main memory 900 only for the image data desired to be prefetched. One advantage of the above approach is that, in average, the memory 420 successively fetches a sufficient amount of sets of data each time in one burst, such that the utilization efficiency of the main memory 900 is effectively enhanced.

As shown in FIG. 6, in one embodiment, the memory controller 420 further includes a stop point determining circuit 424. In practice, once having learned the part of cache miss in the target image data and the image data desired to be prefetched, it can be determined in which memory banks in the main memory 900 the data is distributed according to the addresses of the data. Assuming for the part of target image data that is not stored in the cache, the fetching circuit 423 would fetch image data from N memory banks in the main memory (where N is a positive integer). If the prefetch decision outputted by the deciding circuit 422 indicates that the fetching circuit 423 is to perform the prefetch procedure, the stop point determining circuit 424 determines a stop point of the prefetch procedure and provides the same to the fetching circuit 423. For example, the stop point determining circuit 424 may set the stop point as enabling the fetching circuit 423 to fetch only image data associated with the prefetch procedure from the N memory banks. That is to say, the fetching circuit 423 does not perform additional cross-bank fetching operations for prefetch procedure. One advantage of the above approach that, CAS latency is prevented from further prolonging further due to the prefetch procedure.

The scope of the present invention does not limit the image processing system 400 to be implemented by a specific configuration or architecture. A person skilled in the art can understand that, there are numerous circuit configurations and components for realizing the concept of the present invention without departing from the spirit of the present invention. In practice, the foregoing circuits may be implemented by various control and processing platforms, including fixed and programmable logic circuits such as programmable logic gate arrays, application-specific integrated circuits, microcontrollers, microprocessors, and digital signal processors. Further, these circuits may also be designed to complete tasks thereof through executing processor instructions stored in a memory.

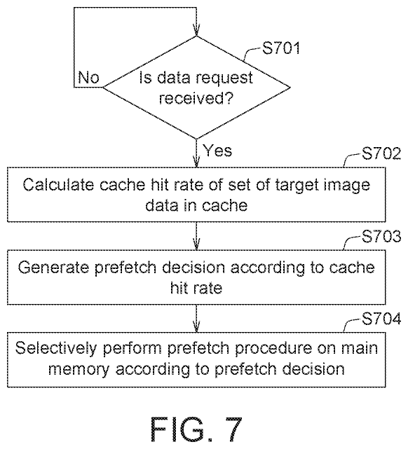

FIG. 7 shows a flowchart of a memory managing method cooperating with an image processing system according to another embodiment of the present invention. The image processing system includes a main memory, a cache and an image processing circuit. The memory managing method includes following steps. In step S701, it is determined whether a data request issued by the image processing circuit for a set of target image data is received. If not, step S701 is iterated. Only when the determination of step S701 is affirmative, step S702 is performed to calculate a cache hit rate of the target image data in the cache. In step S703, a prefetch decision is generated according to the cache hit rate to indicate whether to perform a prefetch procedure. In step S704, the prefetch procedure is selectively performed on the main memory according to the prefetch decision.

A person skilled in the art can conceive of applying the operation variations in the description associated with the image processing system 400 to the memory managing method in FIG. 7, and such repeated details are omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing system, suitable for accessing a main memory, comprising:
a cache;
an image processing circuit; and
a memory controller, comprising:
a hit calculating circuit, in response to a data request issued by the image processing circuit for a set of target image data, calculating a cache hit rate of the set of target image data in the cache;
a deciding circuit, generating a prefetch decision according to the cache hit rate to indicate whether to perform a prefetch procedure; and
a fetching circuit, selectively performing the prefetch procedure on the main memory according to the prefetch decision.

2. The image processing system according to claim 1, wherein the deciding circuit generates the prefetch decision indicating that the prefetch procedure is not to be performed, according to the cache hit rate indicating that all of the set of target image data is stored in the cache, the deciding circuit generates the prefetch decision indicating that the prefetch procedure is to be performed, according to the cache hit rate indicating that not all of the set of target image data is stored in the cache.

3. The image processing system according to claim 1, wherein the cache comprises multiple address fields and multiple data fields, and the hit calculating circuit comprises:
a buffer, buffering an address table;
a duplicating circuit, duplicating contents of the multiple address fields to the address table, and keeping contents of the address table to be consistent with the contents of the multiple address fields;
a converting circuit, converting the data request issued by the image processing circuit to a set of addresses to be inquired;
a searching circuit, searching the address table for the set of addresses to be inquired to accordingly generate a search result; and
a calculating circuit, calculating the search result to generate the cache hit rate.

4. The image processing system according to claim 1, wherein the cache comprises multiple address fields and multiple data fields, and the hit calculating circuit comprises:
a buffer, buffering an address table;
a recording circuit, recording in the address table multiple addresses of multiple of sets of image data recently stored to the cache;
a converting circuit, converting the data request issued by the image processing circuit to a set of addresses to be inquired;
a searching circuit, searching the address table for the set of addresses to be inquired to accordingly generate a search result; and
a calculating circuit, calculating the search result to generate the cache hit rate.

5. The image processing system according to claim 1, wherein the main memory comprises multiple memory banks, the fetching circuit needs to fetch a part of the set of target image data that is not yet stored to the cache from N memory banks of the main memory, N is a positive integer, and the memory controller further comprises:
a stop point determining circuit, determining a stop point of the prefetch procedure to provide to the fetching circuit, wherein the stop point is set in a way that the fetching circuit fetches image data associated with the prefetch procedure within the N memory banks.

6. A memory managing method cooperating with an image processing system, the image processing system being adopted for accessing a main memory, the image processing system comprising a cache and a memory processing circuit, the memory managing method comprising:
(a) calculating, in response to a data request issued by the image processing circuit for a set of target image data, a cache hit rate of the set of target image data in the cache;
(b) generating a prefetch decision according to the cache hit rate to indicate whether to perform a prefetch procedure; and
(c) selectively performing the prefetch procedure on the main memory according to the prefetch decision.

7. The image managing method according to claim 6, wherein step (b) comprises:
if the cache hit rate indicates that all of the set of target image data is stored in the cache, having prefetch decision indicate that the prefetch procedure is not to be performed; and
if the cache hit rate indicates that not all of the set of target image data is stored in the cache, having prefetch decision indicate that the prefetch procedure is to be performed.

8. The image managing method according to claim 6, wherein the cache comprises multiple address fields and multiple data fields, and step (a) comprises:
establishing an address table;
duplicating contents of the multiple address fields to the address table, and maintaining contents of the address table to be consistent with the contents of the multiple address fields;
converting the data request issued by the image processing circuit to a set of addresses to be inquired;
searching the address table for the set of addresses to be inquired to accordingly generate a search result; and
calculating the search result to generate the cache hit rate.

9. The image managing method according to claim 6, wherein the cache comprises multiple address fields and multiple data fields, and step (a) comprises:
establishing an address table;
recording in the address table multiple addresses of multiple of sets of image data recently stored to the cache;
converting the data request issued by the image processing circuit to a set of addresses to be inquired;
searching the address table for the set of addresses to be inquired to accordingly generate a search result; and
calculating the search result to generate the cache hit rate.

10. The image managing method according to claim 6, wherein the main memory comprises multiple memory banks; the memory managing method further comprising:
for a part of the set of target image data that is not yet stored in the cache, fetching image data from N memory banks of the main memory, where N is a positive integer; and
determining a stop point of the prefetch procedure for step (c), wherein the stop point is set in a way that the fetching circuit fetches image data associated with the prefetch procedure within the N memory banks.
